(19) United States
(12) Patent Application Publication
(10) Pub. No.: US 2005/0106304 A1
(43) Pub. Date: May 19, 2005

(54) Sucrose acetate isobutyrate formulation

(76) Inventors: Phillip Michael Cook, Kingsport, TN (US); George Chester Zima, Kingsport, TN (US); Danessa Leann Sexton, Johnson City, TN (US)

Correspondence Address: Jonathan D. Wood;Eastman Chemical Company, P.O. Box 511, Kingsport, TN, 37662-5075, US

(21) Appl. No.: 10/713,937

(22) Filed: Nov. 14, 2003

(51) Int. Cl. C12C 1/00

(52) U.S. Cl. 426/590

(57) ABSTRACT

The present invention provides a solid sucrose acetate isobutyrate (SAIB) formulation, comprising sucrose acetate isobutyrate in an amount from about 1 weight percent to about 80 weight percent based on the total weight percent of the total solid formulation; and a solid substrate that is soluble in water or oil, wherein the substrate is present in an amount from about 99 weight percent to about 30 weight percent based on the weight of the formulation, wherein the formulation is pourable in less than about 20 seconds according to ASTM method D1895-96. The SAIB formulation is useful in beverage applications.

### FIELD OF INVENTION

This invention relates to sucrose acetate isobutyrate (SAIB) formulations, specifically SAIB formulations useful in beverage applications that have improved handling characteristics.

### BACKGROUND OF THE INVENTION

Carbonated and non-carbonated soft drinks, sports drinks, vitamin-fortified beverages, and pre-mixers frequently contain a variety of lipophilic ingredients such as flavors prepared from essential oils, vitamins, natural extracts, and nutraceuticals. Lipophilic ingredients are poorly soluble in water and usually have a density of less than that of water. In beverage applications, the lipophilic ingredients must be evenly dispersed throughout the beverage, typically in an emulsion. Normally, water-soluble materials such as gum arabic (acacia gum) or hydrophobically modified food starches are used to form an emulsion with the lipophilic ingredients.

Emulsification can be accomplished by combining, under high shear, the oil phase, which consists of the lipophilic ingredients, and the aqueous phase, which consists of the water-soluble ingredients. Under the influence of the homogenizer, the lipophilic ingredients are dispersed throughout the aqueous phase to form very small particles. A beverage syrup can then be prepared by diluting a small amount of the emulsion with a variety of aqueous sugar ingredients or dietetic sugar replacements. A final beverage is prepared by diluting the syrup with water and carbonating if desired.

Emulsification of oils in beverages without the assistance of auxiliary ingredients is usually not successful, and results in the beverage having poor stability and a short shelf life. A problem is that the emulsion has a tendency to revert to its original state of two immiscible liquids (i.e., a two phase system: a dispersed phase or oil phase and a continuous aqueous phase). For example, the oil phase can separate and rise to the top of the beverage. This phenomenon is referred to as “creaming” and can manifest itself as an unsightly ring inside the neck of a bottle (a condition commonly referred to as “ringing”) or as powdery “floc” on the shoulder of the bottle. Conversely, the oil phase can become attached to colloidal particles heavier than the water phase, in which case the oil phase will settle to the bottom of the container. This condition may be referred to as “sedimentation” because the cloud appears as sediment on the bottom of the bottle. Sedimentation is often a problem with materials that are not soluble in water or oil, such as silica and titanium dioxide.

Stability of the beverage emulsion can be enhanced by addition of a weighting agent to the oil phase. Weighting agents are lipophilic substances with a density greater than 1.0 g/cm³. Addition of weighting agents in sufficient amounts results in an oil phase with a specific gravity greater than that of the original oil phase and approximately equal to that of the final beverage. The weighting agent thereby decreases the migration of oil droplets to the surface of the beverage, and helps maintain uniform flavor and beverage cloud.

Brominated vegetable oil (BVO) is a common weighting agent. A problem with BVO is that it has been banned in some countries and is subject to maximum acceptable levels of use in the USA, i.e., 15 ppm in the final beverage. A substitute for brominated vegetable oil is ester gum, approved by the FDA as a “glyceryl ester of wood rosin”. Although ester gum can be used to extend the stability of the beverage dispersion, its use is also problematic, specifically, ester gum has a density 1.08 g/cm³ as compared to 1.30 g/cm³ for brominated vegetable oils, thus, about three times as much ester gum is required to achieve the same degree of balancing as is achieved by use of brominated oils. Moreover, too much ester gum may affect the taste of the final beverage causing it to have a bitter rosin-like aftertaste.

More recently, sucrose acetate isobutyrate ((SAIB) (Sustane SAIB, commercially available form Eastman Chemical Company, Kingsport, Tenn.)) has been approved by the FDA, as a direct food additive for use in beverages at the highest level (300 ppm) of usage allowed for any approved beverage weighting agent. Because SAIB has a density of 1.15 g/cm³, it can be used in a lesser amount than ester gum. Moreover, because it is approved at a maximum usage level in the final beverage that is three times (300 ppm) that of ester gum (100 ppm), higher oil-soluble ingredient loadings can be used to produce beverages having a more robust flavor or level of fortification. Higher ingredient loadings, for example, extend the level to which fat soluble vitamins can be added to a fortified beverage. Additionally SAIB has taste neutral, is stable to air oxidation, dissolves quickly in oils, and is highly purified, thus making it a preferred beverage weighting agent.

While SAIB has many exceptional benefits, its high viscosity presents practical difficulties in handling. For example, at room temperature SAIB is a sticky material having a viscosity of greater than 100,000 cP, making pouring practically impossible. To overcome these handling problems, SAIB can be heated or diluted to decrease its viscosity, allowing SAIB to be handled as a liquid. In beverage applications, food grade solvents are used as diluents to make SAIB less viscous (approximately 1,000 to 10,000 cP) and hence more pourable. Eastman Chemical Company currently markets three low-viscosity liquid SAIB products: Sustane SAIB-FG CO (containing 10% orange terpenes), Sustane SAIB-FG ET-10 (containing 10% ethanol), and Sustane SAIB MCT (containing 20% medium chain triglycerides). While resolving the viscosity issues associated with SAIB, the low viscosity blends of SAIB may have certain characteristics that can make them less than desirable in certain applications and in general complicate beverage formulations. For instance, certain solvents, or other auxiliary ingredients may be either undesirable in some formulations or not approved for use in certain countries. Ethanol, for example, is not allowed for use by some cultures. The densities of these blends are also less than that of the original SAIB and so more of the SAIB blend must be used to achieve the same degree of weighting of the oil phase.

In view of these limitations, there is a need for an SAIB formulation that is easy to handle and that can be used in beverage applications as a weighting agent.

### BRIEF SUMMARY OF THE INVENTION

The present invention provides a solid SAIB formulation that overcomes the above mentioned problems. In addition, the present invention provides a solid SAIB formulation that is suitable for use in beverage applications. The solid SAIB formulation may also include processing aids or other ingredients commonly used in beverage applications.

The present invention relates to a sucrose acetate isobutyrate (SAIB) formulation, comprising sucrose acetate isobutyrate in an amount from about 1 weight percent to about 80 weight percent based on the total weight percent of the formulation; and a substrate that is soluble in water or oil, wherein the substrate is present in an amount from about 99 weight percent to about 30 weight percent based on the weight of the formulation, wherein the formulation is a solid and wherein the formulation is pourable in less than about 20 seconds according to ASTM method D1895-96.

The present invention further relates to beverage concentrates, dry beverage mixes and pre-mixers, beverage syrups, carbonated beverages and noncarbonated beverages containing the SAIB formulation.

### DETAILED DESCRIPTION

The present invention may be understood more readily by reference to the following detailed description of the invention and the examples provided therein. It is to be understood that this invention is not limited to the specific formulations, blends, emulsions, beverages, processes and conditions described, as specific formulations, blends, emulsions, beverages, processes and/or process conditions may, of course, vary.

It must also be noted that, as used in the specification and the appended claims, the singular forms “a,” “an” and “the” include plural referents unless the context clearly dictates otherwise.

Ranges may be expressed herein as from “about” a particular value and/or to “about” another particular value. When such a range is expressed, another embodiment includes from the one particular value and/or to the other particular value.

By “comprising” or “containing” is meant that at least the named compound, element, particle, or method step etc. must be present in the formulation or emulsion or method, but does not exclude the presence of other compounds, materials, particles, method steps, etc., even if the other such compounds, materials, particles, method steps etc. have the same function as what is named.

Unless otherwise specified, weight percent is based on the total weight of the formulation, blend or other combination. For example, as stated herein, a sucrose acetate isobutyrate (SAIB) formulation comprising from about 1 weight percent to about 80 weight percent sucrose acetate isobutyrate, and from about 30 weight percent to about 99 weight percent of a substrate soluble in water or oil. The weight percentages of the sucrose acetate isobutyrate and the substrate are based on the total weight of the SAIB formulation.

As used herein the term substrate refers to a material to which SAIB may be combined to form a solid SAIB formulation that has improved handling characteristics, such as pourability as defined in ASTM D1895-96. In a preferred embodiment the substrate is a material on which SAIB is absorbed or adsorbed.

As used herein, the term solid means a substance that is not a gas or liquid at room temperature or temperature of use. The SAIB formulation in the present invention is in a solid form.

As used herein handling characteristics of the SAIB formulation are defined by the pourability, as defined by ASTM method D1895-96, of the solid SAIB formulation at room temperature. If the pourability of the solid SAIB formulation is less than about 20 seconds it is considered to be pourable.

While the use of SAIB as a weighting agent for beverages has many benefits, it is very difficult to physically handle at room temperature. The present invention provides a solid SAIB formulation that has improved handling characteristics. The present invention further comprises an SAIB formulation that is useful in beverages, for example as a weighting agent.

The present invention is directed to a solid SAIB formulation comprising SAIB and a substrate that is soluble in water or oil, wherein the solid formulation is pourable in less than about 20 seconds according to ASTM method D1895-96. In a preferred embodiment the solid formulation is pourable in less than about 15 seconds, more preferably less than about 10 seconds and most preferably pourable in less than about 5 seconds.

The SAIB is present in the solid formulation in an amount from about 1 weight percent to about 80 weight percent, preferably in an amount from about 30 weight percent to about 70 weight percent and more preferably in amount from about 40 weight percent to about 60 weight percent. In the most preferred embodiment, the SAIB is present in the formulation in an amount from about 40 weight percent to about 55 weight percent.

SAIB is commercially available from Eastman Chemical Company, Kingsport, Tenn., and can be prepared using known techniques by reacting sucrose with acetic and isobutyric anhydrides followed by extensive purification using high vacuum distillation. The degree of esterification is nearly complete (e.g., with the degree of substitution being greater than 7.5 and the maximum degree of substitution being 8), and the approximate ratio of acetate:isobutyrate esters is 2:6. U.S. Pat. No. 3,096,324 provides an example of the preparation of SAIB.

The substrate can be any composition that can absorb or adsorb SAIB to form a solid formulation that is pourable in less than about 20 seconds, including sucrose, hydrophobically modified food starch, gum acacia, maltodextrins including soluble maltodextrin fibers (commercially available from Matsutani, and known as Fibersol-2), cyclodextrins, microcrystalline cellulose, silica, titanium dioxide, carboxymethylcellulose, gum ghatti, modified gum ghatti, xanthan gum, tragacanth gum, guar gum, or other suitable gums, inorganic substrates such as sodium/potassium sulfate, talc, bentonite and various clays, waxes such as candellila, hydrocarbon and carnauba waxes. In a preferred embodiment, the substrate is soluble in water or oils such as sucrose, hydrophobically modified food starch, gum acacia, maltodextrins, including soluble maltodextrin fibers (commercially available from Matsutani America, Inc., and known as Fibersol-2), cyclodextrins, microcrystalline cellulose, carboxymethylcellulose, gum ghatti, modified gum ghatti, xanthan gum, tragacanth gum, guar gum, or other suitable gums, waxes such as candellila, hydrocarbon and carnauba waxes.

The substrate is present in an amount from about 30 weight percent to about 99 weight percent, and is preferably present in an amount from about about 45 to about 60 weight percent.

The weight ratio of SAIB and the substrate is dependent upon many factors, including manner of preparation, nature and porosity of the substrate, solubility of the substrate in water, presence of auxiliary ingredients (e.g. essential oils, clouding agents, vitamins, etc.), compatibility of SAIB and the substrate, and numerous others.

In beverage applications, it is preferred that the substrate weight percent be minimized in order to minimize the amount of substrate added to the beverage. This is especially important in beverage applications, if the substrate is not soluble in water, such as waxes and microcrystalline cellulose. Such ingredients are not often used in beverages in an amount greater than about one percent by weight, however it is possible to disperse them in water, so that they will resist the tendency to settle out of the final beverage. In beverage applications, for substrates insoluble in water, the preferred SAIB weight percent weight is about 50 percent to about 90 percent, most preferably about 80 percent to about 90 percent (based on the total weight of the solid formulation).

Substrates that are soluble in water are preferred for beverage applications. The most preferred substrates are those that are commonly used in beverage manufacturing, including modified food starch, gum acacia and sucrose. The preferred SAIB weight percent is about 40 weight percent to about 60 weight percent, and the most preferred weight percent is about 40 weight percent to about 55 weight percent (based on the total weight of the solid formulation).

The present invention is further related to a process for preparing a solid sucrose acetate isobutyrate formulation that is pourable in less than 20 seconds according to ASTM method D1895-96 comprising combining a sucrose acetate butyrate and a substrate that is soluble in water or oil.

SAIB and a substrate can be combined by any suitable means known in the art, such as direct mixing, extrusion coating, spray drying, blending, and encapsulation.

SAIB and a substrate may be combined using a spray drying process. In the spray drying process a solid formulation is generally prepared by a three step operation comprising: (1) forming an emulsion of the SAIB, substrate, and any optional auxiliary processing aid in an aqueous solution; (2) reducing the particles to the desired size, such as by breaking up the emulsion into droplets of desired size, e.g., in a spray nozzle, from a spinning disc, or apertured centrifugal atomizer; and (3) removing moisture in a drying environment to form the solid SAIB formulation. The drying environment may be hot drying air (e.g., in a spray drying tower), a dehydrating liquid (e.g., propylene glycol); a bed of dehydrating powder (e.g., dry starch powder); or the like. The formulations produced by this process vary significantly depending upon the type of substrate used. While the solid SAIB formulation produced by the spray drying may be of various sizes and shapes and may be hollow or has a substantially uniform structure throughout, the solid formulation is characterized by cellular structure comprising many dispersed globules of the core material in a matrix of the coating material. The solid formulation produced by the spray drying process is a dry, somewhat porous powder consisting of roughly aspherical, convoluted particles with the coating material in the solid state and with the SAIB either dispersed as minute droplets throughout the particle, or dissolved in a solid matrix, or both, depending on the compatibility of the SAIB and the substrate.

Combining the SAIB and the substrate can be accomplished in any number of other ways known in the art of mixing liquids and/or solids, such as direct mixing. These include Henschel mixer, Lodige mixer, and V-mixer, and mixing methods based principally on a shear effect such as a colloid mill, ball mill, motorized orbiting mortar and pestle, and roll mill.

Combining the SAIB and the substrate can also be accomplished using a single- or twin-screw extruder. Generally speaking, extruders are industrial devices which include an elongated, tubular barrel, a material inlet at one end of the barrel and a restricted orifice die adjacent the remaining end thereof. One or more elongated, axially rotatable, flighted extrusion screws are situated within the barrel, and serve to transport material along the length thereof. Moreover, the overall extruder is designed to heat, pressurize and render flowable material being processed, typically through the use of high shear and temperature conditions.

An example of an extruder that may be used to combine SAIB and a substrate is the single screw extruder, which includes a single, elongated extruder screw within a substantially circular barrel. Another example of extruders is the so-called twin-screw machines, which have a pair of juxtaposed elongated, flighted screws within a complemental barrel having a pair of side-by-side, frusto-cylindrical sections. The screws in such a twin screw machine can be counter rotating (i.e., the screws rotate in an opposite direction relative to each other), or co-rotating, (i.e. both screws rotate either clockwise or counterclockwise).

Such a process would have two streams commingled at the opening of the extruder: one would be a stream of SAIB, heated to 50° C.-80° C. and the second stream would be a stream of substrate preferably in powder form. The final formulation exits the extruder in the form of a coarse powder like material or “chopped spaghetti” like material depending upon the conditions under which the extruder is operated.

In one embodiment of the present invention, the SAIB formulation can include additional components, such as processing aids useful for facilitating the combination of SAIB and the substrate composition, emulsifiers, diluent solvents, or other components depending on the application, such as triglycerides in beverage applications.

Processing aids may or may not be present in the final SAIB formulation. For example if spray drying is used to prepare the SAIB formulation, then the processing aids might include an organic solvent to help facilitate aqueous emulsification of the SAIB prior to spray drying. Such organic solvents include, but are not limited to, ethanol, acetone, medium chain triglycerides, ethyl acetate, and the like. In addition, emulsifiers may be added to facilitate emulsification of the formulation.

Direct combination of SAIB and the substrate may involve the use of a dilution solvent to reduce the viscosity of the SAIB to facilitate direct combination of the SAIB and the substrate. Such solvents can be subsequently removed by drying to an acceptable residual level, such as <100 ppm.

Another embodiment of the present invention relates to a beverage emulsion comprising water, a solid SAIB formulation, and an emulsifier. The beverage emulsion may further include clouding agents, flavoring oils, acidulants, and antimicrobial agents.

The solid SAIB formulation comprises SAIB and a substrate composition that is soluble in water or oil, as referred to herein above. The solid SAIB formulation is present in the beverage emulsion in an amount from about 1 weight percent to about 80 weight percent, more preferably from about 1 weight percent to about 50 weight percent, and most preferably in an amount from about 1 weight percent to about 40 weight percent. The solid SAIB formulation can function as a weighting agent for beverages, including beverages containing essentially oils, vitamins, plant extracts, nutraceuticals, and the like.

Water is present in the beverage emulsion in an amount sufficient to form an emulsion. The amount of water necessary will be dependent on many variables such as the SAIB formulation, the beverage emulsion application and the clouding agents. In a preferred embodiment, water is present in the beverage emulsion in an amount from about 25 weight percent to about 98 weight percent.

The emulsifiers are those commonly used in food and beverage applications, including but not limited to: mono and di-fatty acid esters of glycerin, mono-, di-, and tri-esters of sucrose, sorbitan esters, polysorbates, steroyl lactylates, and lecithin derivatives, food starch modified by reaction with octenylsuccinic anhydride, and acacia gum. The amount of the emulsifier used will depend on the application.

The preferred emulsifier in the beverage emulsion are typically food starch modified by reaction with octenylsuccinic anhydride and commercially available from a variety of sources (EmCap 12633 by Cargill, Purity Gum 1773 by National Starch and Chemical Company) or acacia gum commercially available from Colloides Naturels International and Tic Gums. The amount of emulsifier present will be dependent on many variables, however is typically present in the beverage emulsion in an amount from about 1 weight percent to about 30 weight percent; preferably present from about 5 weight percent to about 20 weight percent; and most preferably present from about 10 weight percent to about 20 weight percent.

Depending on its use, the beverage emulsion may further comprise a clouding agent. The clouding agent preferably comprises one or more edible triglyceride fats or oils in an amount from about 0.1 weight percent to about 25 weight percent. The triglyceride fats or oils preferably reflect light and have a specific gravity less than that of the beverage in which the clouding agent is to be used.

Any of a variety of fats or oils can be employed as the clouding agent, provided that the fat or oil is suitable for use in foods and beverages. Preferred are those fats and oils which have been refined, bleached and deodorized to remove off-flavors. Refining, bleaching and deodorizing are well-known processes for fats and oils. Specific reference to such treatments can be found in D. Swern, Ed., Bailey's Industrial Oil and Fat Products. 3rd Ed., Interscience Publishers (1964).

The term “fats” used herein shall refer to edible fats and oils comprising triglycerides, fatty acids, fatty alcohols, and esters of such acids and alcohols. Especially appropriate for use in the present invention are triglycerides of straight chain or branched chain saturated monocarboxylic acids having from about 4 to about 24 carbon atoms. Suitable sources of such fats which can be used as clouding agents are: (1) vegetable fats such as soybean, apricot kernel, olive, corn, safflower, sunflower, cottonseed, canola, rapeseed, sesame seed, nasturtium seed, tiger seed, rice bran, wallflower, and mustard seed, (2) animal fats such as tallow, lard and lanolin, (3) marine fats such as menhaden, pilcherd, sardine, whale, or herring, (4) nut fats such as coconut, palm, palm kernel, babassu kernel, or peanut (5) milk fats (butterfat), (6) cocoa butter and cocoa butter substitutes such as shea or illipe butter, and (7) synthetic fats.

Especially suitable for use as clouding agents are those fats which are organoleptically neutral and are readily miscible with a suitable weighting agent. These include fats from the following sources: vegetable fats such as soybean, corn, safflower, sunflower, cottonseed, canola, and rapeseed; nut fats such as coconut, palm, and palm kernel; and synthetic fats.

Unsaturated fats are subject to oxidative degradation, as are the terpenes. Therefore, fats suitable for use herein are substantially saturated fats. “Substantially saturated” is used herein to mean a fat that is less than 100% but predominantly saturated. Preferred are those fats with an iodine value of less than 25, most preferably with an iodine value of less than 8. The more fully saturated the fat is, the less subject it is to oxidative degradation. Thus fully saturated fats are most preferred.

A fat having a sufficiently low iodine value may be obtained by either (1) hydrogenating, or by (2) blending of fats of different iodine values. Hydrogenation can be carried out by conventional methods and usually consists of a batch process whereby the fat composition is contacted with hydrogen in the presence of a nickel catalyst. The solids content of a fat can also be increased by adding to it a small amount of the corresponding fat already saturated to a lower iodine value. The iodine value of a fat indicates the number of grams of iodine equivalent to the halogen absorbed by a 100 gram sample. In general, the lower the iodine value of a given fat, the greater will be its solids content at a given temperature, and the more saturated it will be. The iodine value can readily be determined by known methods.

Also preferred are saturated fats which are liquid at room temperature. Solid fats require heating to achieve liquidity prior to any blending with a flavor or weighting oil and can solidify if the beverage is cooled below the melting point of the fat. The melting points of saturated fatty acids increase as the carbon chain length is increased. Fats of the coconut oil type which contain large proportions of C₆ to C₁₂ acids have low melting points compared to fats containing longer chain length acids and are especially suitable for use herein. Examples include fats containing caproic (hexanoic) and caprylic (octanoic) acids such as milk fats, and coconut and palm kernel oils. Also fats containing capric (decenoic) acid such as milk fats and Palma seed oils are appropriate for use herein.

Fats or mixed fatty acids may be fractionated to obtain a specific fat having the desired characteristics. Fractionated coconut oil is especially suitable for use in the present invention. Lower melting fractions can be obtained by means of thermal fractionation processes in which the higher melting fraction is removed. The desired low melting fraction can be separated and then hydrogenated to the desired iodine value.

Most preferred is glyceryl tri-caprylate/caprate, an almost completely saturated triglyceride. It is made by esterification of from about 40 percent to about 60 percent by weight caprylic acid and from about 40 percent to about 60 percent by weight of capric acid with glycerin. Glyceryl tri-caprylate/caprate is a liquid at room temperature.

The present beverage emulsion may also comprise flavorants or combinations of flavorants and weighting agents. Examples of flavorants comprise one or more flavor oils, extracts, oleoresins and the like, commonly known in the art. Other flavorants include flavor concentrates such as those derived from concentration of natural products such as fruits may also be used. Examples of these flavor concentrates include fruit flavors such as orange, lemon, lime, and the like, cola flavors, tea flavors, coffee flavors, meat flavors, vegetable flavors, chocolate flavors, and others. The flavorants and flavor concentrates can be any suitable flavors, such as those derived from natural sources such as essential oils and extracts, or synthetically prepared. The flavor component typically comprises a blend of various flavors and can be employed in the form of an emulsion.

When desired, antimicrobial agents (preservatives), such as potassium sorbate and sodium benzoate, can be added into the beverage emulsion or the final beverage of the present invention. Amounts ranging from about 0.01 to about 15 weight percent of the beverage emulsion can be used. Chemical preservatives deter microbial growth in beverages, thus enhancing product shelf-life. Conventional chemical food preservatives, i.e., those chemical compounds which are now classified and labeled as food preservatives under U.S. regulations, include sodium and potassium benzoate, sodium and potassium sorbate, and the like. For example, U.S. Pat. Nos. 4,551,342 and 4,737,375 to Nakel et al. teach the use of sodium and potassium salts of benzoic acid to preserve the beverage systems exemplified therein. U.S. Pat. No. 4,996,070 to Nafisi-Movaghar lists sodium benzoate, potassium sorbate and alkyl parabens as examples of anti-microbial agents. U.S. Pat. No. 5,021,251 to McKenna et al. similarly discloses the use of sodium benzoate as a mold inhibitor.

In addition, acidulants may be added to the beverage to perform a variety of functions. For example, acidulants may be added: to enhance the flavor of the foods by imparting a tart, sour taste; to lower pH, thus preventing the growth of bacteria which cause spoilage and food poisoning; and to chelate metal ions such as iron and copper which catalyze rancidity reactions in fats. Commonly used acidulants are citric, acetic, fumaric, ascorbic, propionic, lactic, adipic, malic, sorbic, phosphoric, and tartaric acids. Most of the acidulants are organic acids.

The present invention further includes a method for preparing a beverage emulsion comprising combining a solid SAIB formulation, an emulsifier, and water. The emulsion contains the solid SAIB formulation from about 1 percent to about 80 percent, more preferably from about 1 percent to about 50 percent, and most preferably in an amount from about 1 percent to about 40 percent and from about 25 percent to about 98 percent water, quantum satis. In a preferred embodiment, an optional processing agent included in an amount from about 0.1 weight percent to about 25 weight percent. All percentages are by weight of the total beverage emulsion. Other suitable ingredients such as flavors, color, acid, preservatives can be incorporated into the emulsion if desired.

Examples of emulsifiers suitable for use in the beverage emulsion of the present invention include water-soluble materials such as vegetable gums and starches. Examples include gum acacia, modified food starch, carboxymethylcellulose, gum ghatti, modified gum ghatti, xanthan gum, tragacanth gum, guar gum, or other suitable gums. The emulsifier comprises from about 1 percent to about 40 percent by weight of the beverage emulsion.

The particle size of the water-insoluble components of the beverage emulsion is reduced employing suitable apparatus known in the art. Because the ability of emulsifying agents to hold oil in suspension is proportional to particle size, emulsions of particles with diameters of about 0.1 to about 3.0 microns are suitable for use in this invention. Preferably, the particles are about 2.0 microns or less in diameter. Most preferred is an emulsion in which substantially all the particles are 1.0 microns to about 0.3 microns in diameter. The particle size is reduced by passing the mixture through a homogenizer, colloid mill or turbine-type agitator. Usually one or two passes is sufficient.

Carbonated and noncarbonated beverages, beverage concentrates, and beverage syrups, can be made using the beverage emulsions of the present invention as a component. Included are fruit juices; beverages containing fruit juice such as ades, punches, or the like; ready-to-drink flavored sweetened or diet beverages such as cola, orange, lemon-lime, and other similar flavored soda or soft drinks; vegetable beverages; meat, poultry, or fish broth beverages; milk; coffee and teas; and isotonic (energy) drinks. Beverage concentrates or syrups include the above-listed beverages prior to dilution to drinking strength such as fountain syrups or concentrates used in beverage manufacture.

A beverage concentrate in the amount of 1 gallon can yield up to approximately 200 gallons of syrup of 1200 gallons of finished beverage. Each gallon of syrup would yield approximately 6 gallons of finished beverage. In a concentrate, the beverage emulsion is present in an amount of from about 1 percent to about 75 percent by weight. In a syrup the beverage emulsion is present in an amount of from about 0.005 percent to about 0.4 percent by weight. The beverage emulsion comprises from about 0.0008 percent to about 0.1 percent of the final beverage.

Dry beverage mixes, wherein water or carbonated water is added to the pre-mix powder, can include the SAIB formulation described herein. Examples of dry beverage powders include powdered teas, fruit drinks (e.g., Koolaid®), and sports drinks (e.g., Gatorade®). SAIB formulations are generally used in dry beverage mixes when a weighting agent is desired in the final beverage composition. In a dry beverage pre-mix, the solid SAIB formulation is present in an amount from about 1 weight percent to about 50 weight percent. Other components commonly found in dry beverage pre-mixes may be included herewith. The beverage can further be either a carbonated beverage or a non-carbonated beverage and comprise from about 0.0008 weight percent to about 0.4 weight percent of the beverage emulsion referred to above.

This invention can be further illustrated by the following examples of preferred embodiments thereof, although it will be understood that these examples are included merely for purposes of illustration and are not intended to limit the scope of the invention unless otherwise specifically indicated.

In the following examples the test for pourability is ASTM method D1895-96 entitled “Apparent Density, Bulk Factor, and Pourability of Plastic Materials” which describes a pourability procedure which uses a funnel and a measured weight of sample which is timed as it flows from the funnel. The funnel described in ASTM D1895-96, “Pourability”, 20 Apparatus, page 452, was not available. A plastic vitri 964/10 funnel, having the following dimensions was used:

| | | |
|---|---|---|
| Bottom opening | 2.3 | cm |
| Bottom length before angling (spout length) | 2.5 | cm |
| Top opening | 10.0 | cm |
| Total height (top to bottom) | 9.5 | cm |

Samples of SAIB and the SAIB formulation (samples) were poured out on a piece of paper and any clumps present were dispersed with a spatula. 10.02+/−0.1 grams of samples were then weighed into a glass beaker and poured into the funnel (described above). The bottom part of the funnel was blocked with the glass bottom of a small glass beaker. The beaker was removed and the time determine for the entire sample to flow through the funnel. As used herein the term “pourable” or “pourability” means that the formulation can be poured according to ASTM method D1895-96 in less than 20 seconds.

### EXAMPLE 1a

### Preparation of SAIB/Starch Formulation

An aqueous solution of modified food starch was prepared from 143 g of EmCap 12633 (commercially available form Cargill, Inc., Hammond, Ind.) and 574 g of demineralized water. To this was added under high shear using a Gifford-Wood homogenizer, a solution consisting of 50 g sucrose acetate isobutyrate (SAIB, commercially available for Eastman Chemical Company, Kingsport, Tenn.) and 45 g of ethanol. The resulting emulsion was then spray dried using an APV Anhydro Model Lab 1 spray dryer. The spray dryer operating conditions were:

| | | |
|---|---|---|
| Inlet temperature | 75° | C. |
| Outlet temperature | 55° | C. |
| Atomization pressure | 35 | psig |
| Spray rate | 34.6 | g/minute |
| Product form | <5 | seconds |

### EXAMPLE 1b

### Preparation of SAIB/Starch/Medium Chain Triglycerides Formulation

An aqueous solution of modified food starch was prepared from 143 g of EmCap 12633 (commercially available form Cargill, Inc., Hammond, Ind.) and 574 g of demineralized water. To this was added under high shear using a Gifford-Wood homogenizer, a solution consisting of 100 g sucrose acetate isobutyrate (SAIB, commercially available for Eastman Chemical Company, Kingsport, Tenn.), 10 g of ethanol, and 20 g medium chain triglycerides (commercially known as Neobee M5 and available from Stepan Company, Northfield, Ill.). The resulting emulsion was then spray dried using an APV Anhydro Model Lab 1 spray dryer. The spray dryer operating conditions were the same as above. The resulting formulation was pourable in less than 5 seconds and contained approximately 18-22% medium chain triglycerides of the final formulation.

### EXAMPLE 2

### Alternate Procedure for Making SAIB/Starch Formulation

In a 1L round-bottomed flask was combined 50 grams of modified food starch (Purity Gum 1773 commercially available from National Starch and Chemical, Bridgewater, N.J.) and a solution prepared from 50 grams of sucrose acetate isobutyrate and 100 ml of ethanol. The mixture was evaporated to dryness using a rotary evaporator operated with a vacuum of 10 mm Hg vacuum and water bath temperature of approximately 50° C. The resulting formulation was pourable (less than 5 seconds).

### EXAMPLE 3a

### Preparation of SAIB/Acacia Gum Formulation

An aqueous solution of acacia gum was prepared from 100 g of Instant Gum AS IRX 40830 (commercially available form Colloides Naturels International, Rouen Cédex, France) and 500 g of demineralized water. To this was added under high shear using a Gifford-Wood homogenizer, a solution consisting of 100 g sucrose acetate isobutyrate (SAIB, commercially available for Eastman Chemical Company, Kingsport, Tenn.) and 10 g of ethanol. The resulting emulsion was then spray dried using an APV Anhydro Model Lab 1 spray dryer to form an SAIB formulation. The spray dryer operating conditions were:

| | | |
|---|---|---|
| Inlet temperature | 83° | C. |
| Outlet temperature | 60° | C. |
| Atomization pressure | 35 | psig |
| Spray rate | 32 | g/min |
| Product form | <5 | seconds |

### EXAMPLE 3b

### Preparation of SAIB/Acacia Gum/Medium Chain Triglycerides Formulation

An aqueous solution of acacia gum was prepared from 100 g of Instant Gum AS IRX 40830 (commercially available form Colloides Naturels International, Rouen Cédex, France) and 500 g of demineralized water. To this was added under high shear using a Gifford-Wood homogenizer, a solution consisting of 100 g sucrose acetate isobutyrate (SAIB, commercially available for Eastman Chemical Company, Kingsport, Tenn.), 10 g of ethanol, and 20 g medium chain triglycerides (commercially known as Neobee M5 and available from Stepan Company, Northfield, Ill.). The resulting emulsion was then spray dried using an APV Anhydro Model Lab 1 spray dryer. The spray dryer operating conditions were the same as above. The resulting formulation was pourable (less than 5 seconds) and contained approximately 18-22% medium chain triglycerides by weight of the final formulation.

### EXAMPLE 4

### Preparation of SAIB/Maltodextrin Fiber Formulation

An aqueous solution of maltodextrin powder was prepared from 143 g of Fibersol-2 (commercially available form Matsutani America, Inc., Decatur, Ill.) and 574 g of demineralized water. To this was added under high shear using a Gifford-Wood homogenizer, a solution consisting of 45 g sucrose acetate isobutyrate, 45 g of ethanol, and 5 g of Neobee M5 (medium chain triglyceride blend, commercially available from Stepan Company, Northfield, Ill.). The resulting emulsion was then spray dried using an APV Anhydro Model Lab 1 spray dryer to form a solid SAIB formulation. The spray dryer operating conditions were:

| | | |
|---|---|---|
| Inlet temperature | 80° | C. |
| Outlet temperature | 60° | C. |
| Atomization pressure | 35 | psig |
| Spray rate | 34.9 | g/minute |
| Yield | 80 | g (not optimized) |
| Product form | <5 | seconds |

### EXAMPLE 5

### Preparation of SAIB/Sucrose Formulation

An aqueous solution of sucrose was prepared from 500 g of sucrose and 2000 g of demineralized water. To this was added under high shear using a Gifford-Wood homogenizer, a solution consisting of 500 g sucrose acetate isobutyrate, 200 g of ethanol, and 1 g of sodium dioctylsulfosuccinate surfactant, commercially available from Cytec Industries, West Patterson, N.J.). The resulting emulsion was then spray dried using an APV Anhydro Model Lab 1 spray dryer to form an SAIB formulation. The spray dryer operating conditions were:

| | | |
|---|---|---|
| Inlet temperature | 74° | C. |
| Outlet temperature | 52° | C. |
| Atomization pressure | 35 | psig |
| Spray rate | 23.7 | g/minute |
| Yield | 20 | g (not optimized) |
| Product form | <5 | seconds |

### EXAMPLE 6

### Preparation of SAIB/Silicon Dioxide Formulation

In a 1L round-bottomed flask were combined 45 grams of silicon dioxide (available commercially as Zeosyl 200 from J. M. Huber Corporation, Havre de Grace, Md.) and a solution of 30 grams of sucrose acetate isobutyrate dissolved in 100 ml of ethanol. The mixture was evaporated to dryness using a rotary evaporator operated with 10 mm Hg vacuum and water bath temperature of approximately 50° C. The resulting powder was free-flowing.

### EXAMPLE 7

### Preparation of SAIB/Bees Wax Formulation

Bees wax (from Aldrich Chemical Company, Milwaukee, Wis.)), 100 g, was melted at 60-70° C. in a beaker. Sucrose acetate isobutyrate was added in a single shot and the mixture was stirred by a mechanical agitator as the temperature was allowed to drift downward until the wax hardened. At 25° C., the wax/sucrose acetate isobutyrate mixture was hard and non-tacky. It was readily millable to form a coarse, pourable SAIB formulation.

### EXAMPLE 8

### Preparation of SAIB/Candellila Wax Formulation

Candellila wax (from Aldrich Chemical Company, Milwaukee, Wis.), 100 g, was melted at 60-70° C. in a beaker. Sucrose acetate isobutyrate was added in a single shot and the mixture was stirred by a mechanical agitator as the temperature was allowed to drift downward until the wax hardened. At 25° C., the wax/sucrose acetate isobutyrate mixture was hard and non-tacky. It was readily millable to form a coarse, pourable SAIB formulation.

### EXAMPLE 9

### Preparation of SAIB/Hexadecyl Hexadecanoate Wax Formulation

Hexadecyl hexadecanoate (from Aldrich Chemical Company, Milwaukee, Wis.), 100 g, was melted at 70-80° C. in a beaker. Sucrose acetate isobutyrate was added in a single shot and the mixture was stirred by a mechanical agitator as the temperature was allowed to drift downward until the wax hardened. At 25° C., the wax/sucrose acetate isobutyrate mixture was hard and non-tacky. It was readily millable to form a coarse, pourable (less than 5 seconds) formulation.

### EXAMPLE 10

### Preparation of SAIB/Hydrocarbon Wax Formulation

Hydrocarbon wax (known as CRW 141 and commercially available from Chevron Products Company, San Ramon, Calif.), 100 g, was melted at 60-70° C. in a beaker. Sucrose acetate isobutyrate was added in a single shot and the mixture was stirred by a mechanical agitator as the temperature was allowed to drift downward until the wax hardened. At 25° C., the wax/sucrose acetate isobutyrate mixture was hard and non-tacky. It was readily millable to form a coarse, pourable SAIB formulation.

### EXAMPLE 11

### Preparation of Beverage Emulsion Using SAIB/Starch formulation

A blend of four parts single-fold orange and one part 5-fold orange oil was prepared for use as the flavoring oil. The oil phase was prepared by combining 32.7 grams of the above orange oil blend and 100.1 grams of SAIB/starch formulation prepared according to the recipe of Example 1a. The oil phase slurry containing starch powder was stirred mechanically for approximately 15 minutes, then combined with an aqueous phase containing 973.5 grams of water, 137.4 g of modified food starch (EmCap 12633, commercially available form Cargill, Inc., Hammond, Ind.), 4.4 g of citric acid, and 1.9 g of sodium benzoate and then homogenized using a GreerCo Gifford-Wood High Shear Mixer. The resulting emulsion was deaerated for 18 hours and then homogenized at 6000 psi (two passes) using a two-staged homogenizer (Model 15MR-8TA from APV Gaulin, Inc.). The particle size distribution was determined using a Microtrac UPA instrument. Approximately 99.5% of the oil droplets measured less than 1.06 microns, with Mv=0.53 and Mn=0.33, where Mv is the mean diameter of the volume distribution, and Mn is the mean diameter of the number distribution. Mv is influenced strongly by the number or coarse particles present, while Mn is weighted to small particles.

Percent Composition of Emulsion

| | |
|---|---|
| Orange oil | 2.6% |
| SAIB | 4.0% |
| Starch emulsifier | 15.0% |
| Sodium benzoate, preservative | 0.1% |
| Citric acid, acidulate | 0.35% |
| Water | 78.0% |
| Total | 100% |

The calculated specific gravity of the oil phase was 1.008

### EXAMPLE 12

### Preparation of Beverage Syrup from Emulsion of Example 11

A beverage syrup was prepared by combining 3 grams of emulsion prepared in Example 11 with an aqueous sugar solution containing 105.6 g sucrose, 0.3 g sodium benzoate, 1.3 g citric acid, and 84.8 grams of water.

### EXAMPLE 13

### Preparation of Carbonated Beverage from Syrup of Example 12

A carbonated beverage was prepared by combining in a plastic beverage bottle 80 g of syrup prepared in Example 12 with 400 g of water saturated with carbon dioxide. The turbidity of the final beverage was measured using a Hach turbidimeter Model Ratio/XR. A water blank was used. The container was sealed and shelved for observation. The beverage emulsion continued to be homogeneous with no signs of layer separation or lifting. The final beverage and beverage syrup remained cloudy without formation of any sediment or oil separation. The turbidity of the freshly prepared beverage was determined to be 227 NTU.

### EXAMPLE 14

### Preparation of Beverage Emulsion Using SAIB/Acacia Formulation

A blend of four parts single-fold orange and one part 5-fold orange oil was prepared for use as the flavoring oil. The oil phase was prepared by combining 32.8 grams of the above orange oil blend and 100 grams of SAIB/acacia powder prepared according to the recipe of Example 3a. The oil phase slurry containing acacia powder was stirred mechanically for approximately 15 minutes, then combined with an aqueous phase containing 973.5 grams of water, 137 g of acacia gum (commercially available form Colloides Naturels International, Rouen Cédex, France), 4.4 g of citric acid, and 1.9 g of sodium benzoate and then homogenized using a GreerCo Gifford-Wood High Shear Mixer. The resulting emulsion was de-aerated for 18 hours and then homogenized at 6000 psi (two passes) using a two-staged homogenizer (Model 15MR-8TA from APV Gaulin, Inc.). The particle size distribution was determined using a Microtrac UPA instrument. Approximately 99.9% of the oil droplets measured less than 1.06 microns, with Mv=0.63 and Mn=0.50, where Mv is the mean diameter of the volume distribution, and Mn is the mean diameter of the number distribution. Mv is influenced strongly by he number or coarse particles present, while Mn is weighted to small particles.

Percent Composition of Emulsion

| | |
|---|---|
| Orange oil | 2.6% |
| SAIB | 4.0% |
| Acacia gum emulsifier | 15.0% |
| Sodium benzoate, preservative | 0.1% |
| Citric acid, acidulate | 0.35% |
| Water | 78.0% |
| Total | 100% |

The calculated specific gravity of the oil phase was 1.008

### EXAMPLE 15

### Preparation of Beverage Syrup from Emulsion of Example 14

A beverage syrup was prepared by combining 3 grams of emulsion prepared in Example 14 with an aqueous sugar solution containing 105.6 g sucrose, 0.3 g sodium benzoate, 1.3 g citric acid, and 84.8 grams of water.

### EXAMPLE 16

### Preparation of Carbonated Beverage from Syrup of Example 15

A carbonated beverage was prepared by combining in a plastic beverage bottle 80 g of syrup prepared in Example 15 with 400 g of water saturated with carbon dioxide. The turbidity of the final beverage was measured using a Hach turbidimeter Model Ratio/XR. A water blank was used. The container was sealed and shelved for observation. The beverage emulsion continued to be homogeneous with no signs of layer separation or lifting. The final beverage and beverage syrup remained cloudy without formation of any sediment or oil separation. The turbidity of the freshly prepared beverage was determined to be 161 NTU.

### EXAMPLE 17

### Preparation of Beverage Emulsion Using SAIB/Acacia Powder/Medium Chain Triglycerides

A blend of four parts single-fold orange and one part 5-fold orange oil was prepared for use as the flavoring oil. The oil phase was prepared by combining 32.8 grams of the above orange oil blend and 94 grams of SAIB/acacia gum/medium chain triglycerides (approx. 20% medium chain triglyceride content) powder prepared according to the recipe of Example 3b. The oil phase slurry containing acacia powder was stirred mechanically for approximately 15 minutes, then combined with an aqueous phase containing 973.5 grams of water, 137 g of acacia gum (commercially available form Colloides Naturels International, Rouen Cédex, France), 4.4 g of citric acid, and 1.9 g of sodium benzoate and then homogenized using a GreerCo Gifford-Wood High Shear Mixer. The resulting emulsion was de-aerated for 18 hours and then homogenized at 6000 psi (two passes) using a two-staged homogenizer (Model 15MR-8TA from APV Gaulin, Inc.). The particle size distribution was determined using a Microtrac UPA instrument. Approximately 97.9% of the oil droplets measured less than 1.06 microns, with Mv=0.67 and Mn=0.56, where Mv is the mean diameter of the volume distribution, and Mn is the mean diameter of the number distribution. Mv is influenced strongly by he number or coarse particles present, while Mn is weighted to small particles.

Percent Composition of Emulsion

| | |
|---|---|
| Orange oil | 2.6% |
| SAIB | 3.1% |
| Acacia gum emulsifier | 15.0% |
| Sodium benzoate, preservative | 0.1% |
| Citric acid, acidulate | 0.35% |
| Water | 78.8% |
| Total | 100% |

The calculated specific gravity of the oil phase was 1.008

### EXAMPLE 18

### Preparation of Beverage Syrup from Emulsion of Example 17

A beverage syrup was prepared by combining 3 grams of emulsion prepared in Example 17 with an aqueous sugar solution containing 105.6 g sucrose, 0.3 g sodium benzoate, 1.3 g citric acid, and 84.8 grams of water.

### EXAMPLE 19

### Preparation of Carbonated Beverage from Syrup of Example 18

A carbonated beverage was prepared by combining in a plastic beverage bottle 80 g of syrup prepared in Example 18 with 400 g of water saturated with carbon dioxide. The turbidity of the final beverage was measured using a Hach turbidimeter Model Ratio/XR. A water blank was used. The container was sealed and shelved for observation. The beverage emulsion continued to be homogeneous with no signs of layer separation or lifting. The final beverage and beverage syrup remained cloudy without formation of any sediment or oil separation. The turbidity of the freshly prepared beverage was determined to be 277 NTU.

### EXAMPLE 20

### Preparation of Beverage Emulsion form SAIB:silicon Dioxide Formulation Prepared in Example 6

A blend of four parts single-fold orange and one part 5-fold orange oil was prepared for use as the flavoring oil. The oil phase was prepared by combining 75 grams of the above orange oil blend and 266 grams of SAIB/silicon dioxide powder prepared according to the recipe of Example 6. The oil phase slurry containing silicon dioxide powder was stirred mechanically for approximately 15 minutes, then combined with an aqueous phase containing 876 grams of water, 188 g of acacia gum (commercially available form Colloides Naturels International, Rouen Cédex, France), 4.4 g of citric acid, and 1.3 g of sodium benzoate and then homogenized using a GreerCo Gifford-Wood High Shear Mixer. The resulting emulsion was de-aerated for 18 hours and then homogenized at 6000 psi (two passes) using a two-staged homogenizer (Model 15MR-8TA from APV Gaulin, Inc.). The particle size distribution was determined using a Microtrac UPA instrument. Approximately 86.7% of the oil droplets measured less than 1.06 microns, with Mv=0.99 and Mn=0.82, where Mv is the mean diameter of the volume distribution, and Mn is the mean diameter of the number distribution. The emulsion contained silicon dioxide powder that accumulated on the bottom of the container. This was judged to be unsatisfactory and therefore a beverage syrup was not prepared.

Percent Composition of Emulsion not
including the silicon dioxide.

| | |
|---|---|
| Orange oil | 6.0% |
| SAIB | 8.5% |
| Acacia gum emulsifier | 15.0% |
| Sodium benzoate, preservative | 0.1% |
| Citric acid, acidulate | 0.35% |
| Water | 78.8% |
| Total | 100% |

The calculated specific gravity of the oil phase (not including silicon dioxide) was 1.002

The invention has been described in detail with particular reference to preferred embodiments thereof, but it will be understood that variations and modifications can be effected within the spirit and scope of the invention.

1. A formulation comprising:
sucrose acetate isobutyrate in an amount from about 1 weight percent to about 80 weight percent based on the weight percent of the formulation; and
a substrate that is soluble in water or oil, wherein the substrate is present in an amount from about 30 weight percent to about 99 weight percent based on the weight percent of the formulation,
wherein the formulation is a solid and wherein the formulation is pourable in less than about 20 seconds according to ASTM method D1895-96.

2. A formulation as recited in claim 1, wherein the sucrose acetate isobutyrate is present in an amount from about 30 weight percent to about 70 weight percent.

3. A formulation as recited in claim 1, wherein the sucrose acetate isobutyrate is present in an amount from about 40 weight percent to about 60 weight percent.

4. A formulation as recited in claim 1, wherein the sucrose acetate isobutyrate is present in an amount from about 40 weight percent to about 55 weight percent.

5. A formulation as recited in claim 1, wherein the substrate is present in an amount from about 40 weight percent to about 60 weight percent.

6. A formulation as recited in claim 1, wherein the formulation is pourable in less than about 10 seconds.

7. A formulation as recited in claim 1, wherein the formulation is pourable in less than about 5 seconds.

8. A formulation as recited in claim 1, wherein the substrate is selected from the group consisting of sucrose, hydrophobically modified food starch, gum acacia, maltodextrins, cyclodextrins, microcrystalline cellulose, carboxymethyl cellulose, gum ghatti, modified gum ghatti, xanthan gum, tragacanth gum, guar gum, candellila wax, hydrocarbon wax and carnauba wax.

9. A sucrose acetate isobutyrate formulation as recited in claim 1, further comprising a processing aid.

10. A sucrose acetate isobutyrate formulation as recited in claim 1, further comprising an emulsifier.

11. A sucrose acetate isobutyrate formulation as recited in claim 10, wherein the emulsifier is gum acacia and modified food starch.

12. A sucrose acetate isobutyrate formulation as recited in claim 1, further comprising a medium chain triglyceride.

13. A formulation as recited in claim 1, wherein the substrate is acacia gum or modified food starch.

14. A formulation as recited in claim 8, wherein the substrate is selected from the group consisting of hydrophobically modified food starch, gum acacia and sucrose.

15. A beverage emulsion comprising from about 1 weight percent to about 30 weight percent of the sucrose acetate isobutyrate formulation of claim 1, from about 1 weight percent to about 40 weight percent of an emulsifier, and from about 25 weigh percent to about 98 weight percent water.

16. A beverage emulsion as recited in claim 15, further comprising a clouding agent in an amount from about 0.1 weight percent to about 25 weight percent.

17. A beverage emulsion as recited in claim 16, wherein the clouding agent is a triglyceride fat.

18. A beverage emulsion as recited in claim 17, wherein the clouding agent is glyceryl tri-caprylate/caprate.

19. A beverage concentrate comprising about 1 weight percent to about 75 weight percent of the emulsion of claim 10.

20. A beverage syrup comprising from about 0.005 weight percent to about 0.4 weight percent of the emulsion of claim 10.

21. A carbonated beverage comprising from about 0.0008 weight percent to about 0.4 weight percent of the beverage emulsion of claim 10.

22. A non-carbonated beverage comprising from about 0.0008 weight percent to about 0.4 weight percent of the beverage emulsion of claim 10.

23. A dry beverage pre-mix comprising from about 1 weight percent to about 50 weight percent of the sucrose acetate isobutyrate formulation of claim 1.
